(19) United States
(12) Patent Application Publication
(10) Pub. No.: US 2026/0167069 A1
(43) Pub. Date: Jun. 18, 2026

(54) SEAT APPARATUS

(71) Applicants: Hyundai Motor Company, Seoul (KR); Kia Corporation, Seoul (KR); DAE WON SAN UP CO., LTD., Ansan-si (KR)

(72) Inventors: Mu Young KIM, Hwaseong-Si (KR); Jong Min Park, Hwaseong-Si (KR); Dae Myoung Park, Hwaseong-Si (KR); Sung Ho Park, Hwaseong-Si (KR); Sang Woo Kim, Hwaseong-Si (KR); Yeon Soo Eo, Hwaseong-Si (KR); Min Ha Lee, Hwaseong-Si (KR); Min Sik Kim, Hwaseong-Si (KR); Da Yeong Kim, Hwaseong-Si (KR); Young Joo Cho, Hwaseong-si (KR); Soo Beom Kwak, Hwaseoang-Si (KR); Hee Dong Choi, Hwaseoang-Si (KR); Seok Ju Gim, Hwaseoang-Si (KR); Hyuk Kim, Ansan-Si (KR); Jong Seong Lee, Ansan-Si (KR); Jong Hyuk Jeong, Incheon (KR); Yong Cheol Jang, Ansan-si (KR)

(21) Appl. No.: 19/280,380

(22) Filed: Jul. 25, 2025

(30) Foreign Application Priority Data
Dec. 12, 2024 (KR) 10-2024-0185150

(51) Int. Cl. B60N 2/30; B60N 2/68; B60N 2/90

(52) U.S. Cl. CPC B60N 2/3013; B60N 2/68; B60N 2/90

(57) ABSTRACT

The present disclosure relates to a seat apparatus including a seat frame; a connection bracket coupled to the seat frame; and a back frame comprising a hinge portion and a distal end portion. The hinge portion may be coupled to the connection bracket. The seat apparatus may further include: a first connection shaft coupled to the seat frame and configured to raise or lower the seat frame; and a second connection shaft coupled to the connection bracket and the back frame. The back frame may be configured to pivot around the second connection shaft between: a flat position, in which the hinge portion and the distal end portion are arranged in a horizontal direction, and a reclined position, in which the distal end portion is reclined and disposed to be further away from the seat frame than the hinge portion.

### CROSS-REFERENCE TO RELATED APPLICATION

This application claims priority to Korean Patent Application No. 10-2024-0185150, filed in the Korean Intellectual Property Office on Dec. 12, 2024, the entire contents of which are incorporated herein by reference.

### TECHNICAL FIELD

The present disclosure relates to a seat apparatus.

### BACKGROUND

A sports utility vehicle (SUV), which combines aspects of passenger vehicles and trucks, may be advantageous with respect to a generous amount of space for its passengers. In particular, space for rear passengers of the SUV may be used for various purposes.

A seat apparatus mounted in the rear space of the SUV can be folded down to optimize the rear space of the SUV or allowing rear passengers to have increased legroom or tilt their seat backs for a more comfortable posture. After the seat apparatus is folded, a seat frame provided to support the user may need to be lowered, thus making it more difficult to utilize the space below the seat frame as a storage space.

Thus, there exists a need for technologies that allow better utilization of spaces around (e.g., below) a seat apparatus in its folded position.

### SUMMARY

The present disclosure has been made to solve the above-mentioned problems occurring in the prior art while advantages achieved by the prior art are maintained intact.

An aspect of the present disclosure provides a seat apparatus that may utilize a lower space of a seat frame as a storage space when the seat apparatus is folded.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a seat apparatus may include: a seat frame; a connection bracket coupled to the seat frame; a back frame including a hinge portion and a distal end portion; a first connection shaft coupled to the seat frame and configured to raise or lower the seat frame; and a second connection shaft coupled to the connection bracket and the back frame. The hinge portion may be coupled to the connection bracket. The back frame may be configured to pivot around the second connection shaft between: a flat position, in which the hinge portion and the distal end portion are arranged in a horizontal direction; and a reclined position, in which the distal end portion is reclined and disposed to be further away from the seat frame than the hinge portion.

The seat frame may include a first moveable attachment site, to which the first connection shaft is coupled. The first moveable attachment site may be configured to move between: a first position, in which the back frame is disposed in the flat position, and a second position, in which the back frame is disposed in the reclined position. The first position of the first moveable attachment site may be higher than the second position of the first moveable attachment site.

The seat apparatus may further include: a base frame; and a fixing bracket connecting to the base frame and the seat frame. The seat frame may further include a non-movable attachment site, to which the fixing bracket is coupled. The first position of the first moveable attachment site may be higher than a position of the non-movable attachment site. The second position of the first moveable attachment site may be lower than the position of the non-movable attachment site.

The seat apparatus may further include: a non-moveable shaft connecting to the seat frame and the fixing bracket. The seat frame may be configured to pivot around the non-moveable shaft.

The seat apparatus may further include: a motor assembly configured to generate mechanical power; and a linkage assembly connecting to the motor assembly and the first connection shaft, and configured to transmit the mechanical power generated by the motor assembly to the first connection shaft to raise or lower the first connection shaft and cause pivoting movement of the back frame.

The linkage assembly may include: a pivot arm; a pivot arm shaft coupled to the pivot arm; and a connection link connecting to the pivot arm shaft and the first connection shaft.

The motor assembly may include a motor and a driving gear. The motor may be configured to rotate the driving gear. The pivot arm may include a sector gear configured to engage the driving gear.

The sector gear may be disposed at a first end portion of the pivot arm. A second end portion of the pivot arm is coupled to the pivot arm shaft.

The connection link may be configured to: raise the first connection shaft to pivot the back frame to the flat position; and lower the first connection shaft to pivot the back frame to the reclined position.

A first angle between the pivot arm and the connection link when the back frame is disposed in the flat position may be greater than a second angle between the pivot arm and the connection link when the back frame is disposed in the reclined position.

The connection link may include a first connection link and a second connection link. The pivot arm may be connected to a first end of the pivot arm shaft. The linkage assembly may further include a pivot link coupled to a second end of the pivot arm shaft. A first end of the first connection shaft may be coupled to the first connection link. A second end of the first connection shaft may be coupled to the second connection link.

The seat apparatus may further include: a base frame. The linkage assembly may further include: a link bracket which is affixed to the base frame and to which the pivot link is rotatably coupled.

The seat apparatus may further include: a base frame. The motor assembly may further include: a motor bracket coupled to the base frame and configured to affix the motor to the base frame.

The seat frame may include a second moveable attachment site, to which the connection bracket is coupled. The seat apparatus may further include a third connection shaft disposed behind the first connection shaft. The third connection shaft may connect to the connection bracket and the second moveable attachment site of the seat frame.

According to one or more example embodiments of the present disclosure, a seat apparatus may include: a seat base assembly configured to affix to a floor of a vehicle; and a bottom seat assembly. A front portion of the bottom seat assembly may be coupled, via a first pivot shaft, to a front portion of the seat base assembly. The bottom seat assembly may be configured to pivot around the first pivot shaft. The seat apparatus may further include: a top seat assembly coupled to a back portion of the bottom seat assembly; a jointed linkage including a first link arm and a second link arm; and a motor assembly coupled to the seat base assembly and engaging the jointed linkage. The first link arm of the jointed linkage may be coupled to the second link arm of the jointed linkage. The first link arm may be coupled, via a second pivot shaft, to a back portion of the seat base assembly. The second link arm may be coupled, via a third pivot shaft, to the bottom seat assembly, such that the seat base assembly, the bottom seat assembly, and the jointed linkage form a closed-chain moveable linkage. The motor assembly may be configured to provide mechanical power to operate the closed-chain moveable linkage to raise or lower the back portion of the bottom seat assembly relative to the front portion of the bottom seat assembly.

The first link arm may include a sector gear. The motor assembly may include: a driving gear engaged to the sector gear; and a motor coupled to the driving gear and configured to cause, via the driving gear and the sector gear, the first link arm to pivot around the second pivot shaft.

The top seat assembly may be coupled, via a fourth pivot shaft, to the back portion of the bottom seat assembly. The top seat assembly may be configured to pivot around the second pivot shaft between a folded position and a reclined position.

The motor assembly may be configured to, based on the top seat assembly being disposed in the folded position, operate the closed-chain moveable linkage such that a top surface of the top seat assembly, in the folded position, is positioned to be parallel to the floor of the vehicle.

The seat apparatus may further include: one or more sensors configured to generate a signal indicating a rotational position, relative to the floor of the vehicle, of the top seat assembly. The motor assembly may further include a controller communicatively connected to the one or more sensors. The controller may be configured to operate, based on the signal received from the one or more sensors, the closed-chain moveable linkage such that the top surface of the top seat assembly, in the folded position, is positioned to be parallel to the floor of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view of a seat apparatus;

FIG. 2 is a side view of the seat apparatus;

FIG. 3 is a rear perspective view of the seat apparatus;

FIG. 4 is an enlarged view of the seat apparatus;

FIG. 5 is an exploded perspective view of a seat frame, a fixing shaft, a motor assembly, and a linkage assembly;

FIG. 6 is a side view of the seat apparatus before a back frame is rotated (e.g., pivoted) to a flat position;

FIG. 7 is a side view of the seat apparatus when the back frame is rotated (e.g., pivoted) to the flat position;

FIG. 8 is an enlarged view of the seat frame, a first connection shaft, the motor assembly, and the linkage assembly when the back frame is located at the flat position;

FIG. 9 is a side view of the seat apparatus in a state in which the back frame is rotated (e.g., pivoted) to the flat position;

FIG. 10 is a side view of the seat apparatus before the back frame is rotated (e.g., pivoted) to a reclined position;

FIG. 11 is a side view of the seat apparatus before the back frame is rotated (e.g., pivoted) to the reclined position;

FIG. 12 is an enlarged view of the seat frame, the first connection shaft, the motor assembly, and the linkage assembly when the back frame is located at the reclined position; and

FIG. 13 is a side view of the seat apparatus in a state in which the back frame is rotated to the reclined position.

### DETAILED DESCRIPTION

Hereinafter, one or more example embodiments of the present disclosure will be described in detail with reference to the exemplary drawings. In adding reference numerals to components of each drawing, it should be noted that identical or equivalent components are designated by an identical numeral even when they are displayed on other drawings. Further, in describing the example embodiment of the present disclosure, a detailed description of the related known configuration or function will be omitted if the detailed description may interfere with the understanding of the example embodiment of the present disclosure.

Further, in describing the components of the example embodiments of the present disclosure, terms, such as first, second, “A”, “B”, (a), and (b) may be used. These terms are merely intended to distinguish one component from other components, and the terms do not limit the nature, order, or sequence of the components. Unless otherwise defined, all terms including technical and scientific terms used herein include the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Unless otherwise defined, the terms used herein, including technical or scientific terms, may have meanings generally understood by those skilled in the art to which the present disclosure belongs.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

The expression “based on” as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is directly connected or coupled to another component, or alternatively, it may mean that the component is connected or coupled through yet another component (e.g., a third component).

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

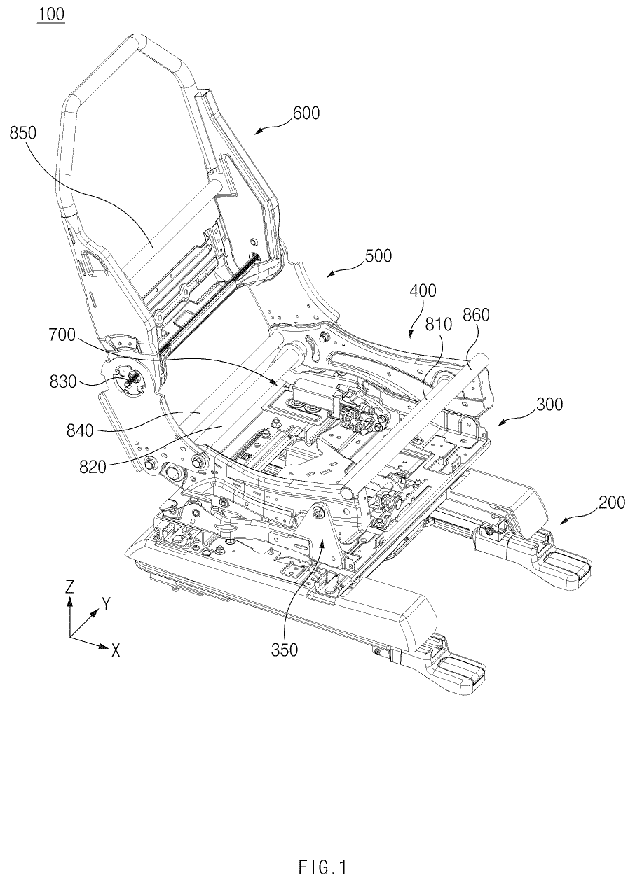

Hereinafter, one or more example embodiments of the present disclosure will be described in detail with reference to FIGS. 1 through 13. As described herein, a first direction (e.g., the “X” direction as indicated in the drawings) may correspond to a forward direction. An object facing in the first direction may be referred to as facing “forward.” An object located further along the first direction, in relative terms, may be described as being “front.” The opposite direction of the first direction (e.g., the opposite direction of the “X” direction as indicated in the drawings) may correspond to a “backward” or “rearward” direction. An object facing in the opposite direction of the first direction may be referred to as facing “backward.” An object located further along the opposite direction of the first direction, in relative terms, may be described as being “rear.” A second direction (e.g., the “Y” direction as indicated in the drawings) may correspond to a leftward direction. An object facing in the second direction may be referred to as facing “left.” An object located further along the second direction, in relative terms, may be described as being “left.” The opposite direction of the second direction (e.g., the opposite direction of the “Y” direction as indicated in the drawings) may correspond to a rightward direction. An object facing in the opposite direction of the second direction may be referred to as facing “rightward.” An object located further along the opposite direction of the first direction, in relative terms, may be described as being “right.” A third direction (e.g., the “Z” direction as indicated in the drawings) may correspond to an upward direction. An object facing in the third direction may be referred to as facing “upward.” An object located further along the third direction, in relative terms, may be described as being “up” or “top.” The opposite direction of the third direction (e.g., the opposite direction of the “Z” direction as indicated in the drawings) may correspond to a “downward” direction. An object located further along the opposite direction of the third direction, in relative terms, may be described as being “down” or bottom.”. Further, each of the first direction, the second direction, and the third direction may be perpendicular (e.g., orthogonal) to the remaining two directions. The first direction (or the opposite direction thereof) may be also referred to as the longitudinal direction or longitudinal orientation. The second direction (or the opposite direction thereof) may be also referred to as the lateral direction or lateral orientation. The third direction (or the opposite direction thereof) may be also referred to as the vertical direction or vertical orientation.

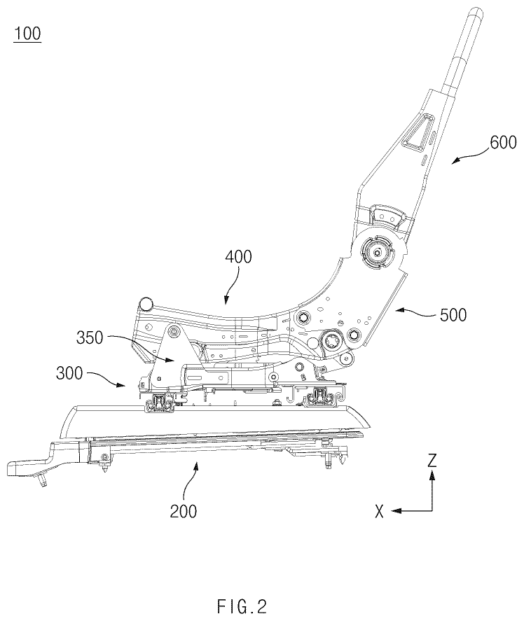

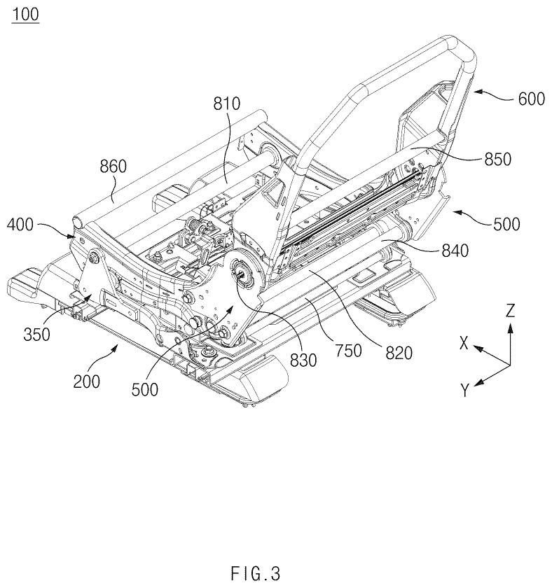

FIG. 1 is a perspective view of a seat apparatus. FIG. 2 is a side view of the seat apparatus. FIG. 3 is a rear perspective view of the seat apparatus.

Referring to FIGS. 1 through 3, a seat apparatus 100 may be mounted in a rear space of a vehicle, such as an SUV. However, a mounting target of the seat apparatus 100 is not limited to the SUV and may be mounted on any type of vehicle.

The seat apparatus (also referred to as a seat, a car seat, a vehicle seat, a seating apparatus, etc.) 100 may include a seat rail (also referred to as a seat railing) 200, a base frame 300, a fixing bracket (also referred to as a fixed bracket, a static bracket, a stabilizing bracket, a stabilizer bracket, a non-moving bracket, a non-movable bracket, etc.) 350, a seat frame 400, a connection bracket 500, a back frame 600, and a motor assembly (also referred to as a driving part) 700.

The seating rail 200 may be affixed to and supported by the vehicle (e.g., a floor, such as an interior floor, of a vehicle). The seating rail 200 may be provided as a pair of seating frames 200. The seating rail 200 may extend in the longitudinal direction (e.g., the “X” direction or the opposite direction of the “X” direction). The pair of seat rails 200 may, for example, run parallel to each other in the longitudinal direction. The pair of seating frames 200 may be spaced apart from each other in the second direction (e.g., the “Y” direction or the opposite direction thereof).

The base frame 300 may be supported by (e.g., on top of) the pair of seating frames 200. The base frame 300 may have a hollow rectangular shape. The base frame 300 may be disposed further along the second direction (e.g., the “Y” direction) or the opposite direction thereof, relative to the seating rail 200. In other words, the base frame 300 may be out of alignment with the seat rail 200 along the lateral direction.

The fixing bracket 350 may be coupled to the base frame 300. The fixing bracket 350 may be provided as a couple of fixing brackets 350, each of which is coupled to either side (e.g., the left side and the right side) of the base frame 300. The fixing bracket 350 may be provided as a pair of fixing brackets 350, and the pair of fixing brackets 350 may be coupled to both end portions of the base frame 300 in the second direction (e.g., the “Y” direction or the opposite direction thereof). The fixing bracket 350 may support the seat frame 400. The fixing bracket 350 may connect the seat frame 400 to the base frame 300.

The seat frame 400 may be a frame in which a cushion part (e.g., one or more cushions) is provided so that a user of the vehicle feels comfortable when seated. The seat frame 400 may be provided as a pair of seat frames 400 and may extend along the first direction (e.g., the “X” direction) or the opposite direction thereof). The pair of seat frames 400 may be spaced apart from each other in the second direction (e.g., the “Y” direction or the opposite direction thereof) and supported by the pair of fixing brackets 350.

The connection bracket 500 may be coupled to the seat frame 400. One side of the connection bracket 500 may be coupled to the seat frame 400, and the other side of the connection bracket 500 may be coupled to the back frame 600.

The back frame 600 may be rotatably coupled to the connection bracket 500. The back frame 600 may be a frame in which a cushion part that supports a back of the user is provided.

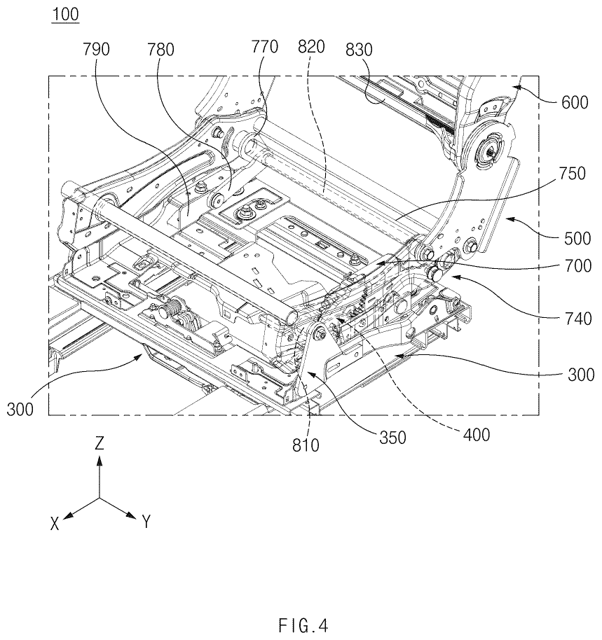

The motor assembly 700 may be formed to rotate the back frame 600. The motor assembly 700 may be fixed to the base frame 300. The motor assembly 700 may rotate the back frame 600 through a linkage assembly (also referred to as a guide part or a jointed linkage assembly) 740 (see FIG. 4).

The seat apparatus 100 may include a fixing shaft (also referred to as a non-moveable shaft, a pivot shaft, a fixed shaft, or a static shaft) 810, a first connection shaft 820, a second connection shaft 830, a third connection shaft 840, a fourth connection shaft 850, and a seating shaft 860. The fixing shaft 810 may be a pivot shaft that may move rotationally but not axially, radially, or laterally, relatively to the base frame 300 and/or the fixing brackets 350. The second connection shaft 830 may be a pivot shaft, which the back frame 600 may pivot around. Each of the first connection shaft 820, the second connection shaft 830, and the third connection shaft 840 may be allowed to move laterally (e.g., in a horizontal or vertical direction) relative to the base frame 300 and/or the fixing brackets 350.

The fixing shaft 810 may extend in the second direction (e.g., the “Y” direction or the opposite direction thereof) to couple the pair of fixing brackets 350 and the pair of seat frames 400. The fixing shaft 810 may connect the seat frame 400 and the fixing bracket 350. The seat frame 400 may be formed to rotate (e.g., pivot) around the fixing shaft 810. In other words, the axis of rotation of the seat frame 400 may be located along the fixing shaft 810.

The first connection shaft 820 may extend in the second direction (e.g., the “Y” direction or the opposite direction thereof) such that the first connection shaft 820 is coupled to the pair of seat frames 400. The first connection shaft 820 may be coupled to the seat frame 400. The first connection shaft 820 may be formed to raise or lower the seat frame 400.

The second connection shaft 830 may extend in the second direction (e.g., the “Y” direction or the opposite direction thereof) to connect the pair of connection brackets 500 and the back frame 600. The second connection shaft 830 may be coupled to the connection bracket 500 and the back frame 600. The second connection shaft 830 may be formed to rotate (e.g., pivot) the back frame 600 about (e.g., around) the connection bracket 500.

The third connection shaft 840 may be disposed adjacent to the first connection shaft 820. The third connection shaft 840 may extend in the second direction (e.g., the “Y” direction or the opposite direction thereof) to couple the seat frame 400 and the connection bracket 500. The third connection shaft 840 may connect the seat frame 400 and the connection bracket 500 and may be located on the other side (e.g., the opposite direction of the “X” direction) in the first direction further than the first connection shaft 820.

The first connection shaft 820 may be configured to raise or lower the seat frame 400, and the second connection shaft 830 may be configured to firmly support the other side (e.g., located in the opposite direction of the “X” direction) of the seat frame 400 in the first direction.

The fourth connection shaft 850 may be coupled to both ends of the back frame 600 in the second direction (e.g., the “Y” direction or the opposite direction thereof). The fourth connection shaft 850 may be formed in an opening of the back frame 600 to form a portion of the frame.

The seating shaft 860 may be seated on one side (e.g., the “X” direction) of the pair of seat frames 400 in the first direction.

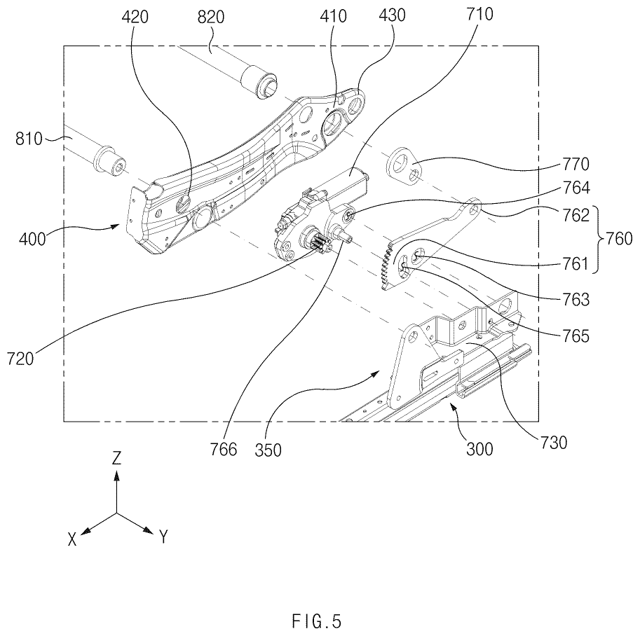

FIG. 4 is an enlarged view of the seat apparatus. FIG. 5 is an exploded perspective view of a seat frame, a fixing shaft, a motor assembly, and a linkage assembly.

Referring to FIGS. 4 and 5, the seat apparatus 100 may include the motor assembly 700 and the linkage assembly 740. The motor assembly 700 may raise or lower the first connection shaft 820 (see FIG. 3) through the linkage assembly 740.

In more detail, the motor assembly 700 may include a driving motor (e.g., a motor, an actuator, a servo, etc.) 710, a driving gear 720, and a motor bracket 730.

The driving motor 710 may be connected to the driving gear 720 to rotate the driving gear 720. The driving gear 720 may be rotated by the driving motor 710. The motor bracket 730 may be coupled to the base frame 300 to fix (e.g., affix, attach, stabilize, etc.) the driving motor 710.

The linkage assembly 740 may connect the motor assembly 700 and the first connection shaft 820 to raise or lower the first connection shaft 820 by the motor assembly 700. The linkage assembly 740 may include a guide shaft (also referred to as a pivot arm shaft) 750, a guide link (also referred to as a pivot arm, a link arm, or a lever) 760, a connection link (also referred to as a link arm) 770, a rotation link (also referred to as a pivot link) 780, and a link bracket 790.

The guide shaft 750 may be raised or lowered by the guide link 760. The guide shaft 750 may extend in the second direction (e.g., the “Y” direction or the opposite direction thereof). One end of the guide shaft 750 may be coupled to one of the pair of seat frames 400, and an opposite end of the guide shaft 750 may be coupled to the other one of the pair of seat frames 400.

The seat frame 400 may include a first connection area (also referred to as a first moveable attachment site) 410 connected to the first connection shaft 820, a fixing area (also referred to as a non-moveable attachment site) 420, to which the fixing bracket 350 is connected via the fixing shaft 810, and a second connection area (also referred to as a second moveable attachment site) 430, to which the connection bracket 500 is connected via the third connection shaft 840. The second connection area 430 may be a portion connected to the connection bracket 500 by the third connection shaft 840.

When the first connection shaft 820 is raised, the first connection area 410 may be raised, and when the first connection shaft 820 is lowered, the first connection area 410 may be lowered. Unlike this, even when the first connection shaft 820 is raised or lowered, the first fixing area 420 may not be raised or lowered.

The guide link 760 may be engaged with the driving gear 720. The guide link 760 may be formed to rotate (e.g., pivot), for example, around the fixing shaft 810. The guide link 760 may include one end portion 761 engaged with the driving gear 720 and the other end portion 762 connected to the guide shaft 750.

The one end portion 761 of the guide link 760 may include a sector gear. The one end portion 761 of the guide link 760 may be formed as a sector gear and engaged with the driving gear 720.

The connection link 770 may be configured to connect the guide shaft 750 to the first connection shaft 820. The connection link 770 may be coupled to the guide shaft 750 on one side thereof and may be coupled to the first connection shaft 820 on the other side thereof.

Due to this structure, when the driving motor 710 is operated, the driving gear 720 may be rotated, and when the driving gear 720 is rotated, the guide link 760 may be rotated (e.g., pivoted). For example, the guide link 760 may be coupled to the base frame 300 and/or the motor assembly 700. For example, the guide link 760 may be coupled to the base frame 300 and/or the motor assembly 700 such that that the guide link 760 may rotate (e.g., pivot) around a pivot, such as a pivot shaft coupled to the base frame 300 and/or the motor assembly 700. As shown in FIGS. 5, 8, and 12, a connection shaft (also referred to as a pivot shaft) 870 may pass through a pivot hole 763 of the guide link 760 and connect to the motor assembly 700 (e.g., through a hole (e.g., a bore) 764 in the motor assembly 700), the motor bracket 730, and/or the base frame 300, such that the guide link 760 may pivot around the connection shaft 870 and/or the pivot hole 763. An arc slot 765 may be formed on the guide link 760, and a guide pin 766, disposed on the motor assembly 700 and/or the motor bracket 730, may pass through the arc slot 765 to guide and/or restrict the rotational movement of the guide link 760 (e.g., within a predetermined angular range of rotational movement). When the guide link 760 is rotated, the guide shaft 750 connected to the guide link 760 may be raised or lowered.

When the guide shaft 750 is raised, the first connection shaft 820 may also be raised by the connection link 770, and the first connection area 410 of the seat frame 400 may be raised. When the guide shaft 750 is lowered, the first connection shaft 820 may also be lowered by the connection link 770, and the first connection area 410 of the seat frame 400 may be lowered.

The connection link 770 may be provided as a pair of connection links 770. The guide shaft 750 may be connected to the pair of connection links 770 on both sides in the second direction (e.g., the “Y” direction or the opposite direction thereof).

The guide shaft 750 may be connected to the guide link 760 on the one side (e.g., the “Y” direction) in the second direction and may be connected to the rotation link 780 on the other side (e.g., the opposite direction of the “Y” direction) in the second direction.

Unlike the guide link 760, the rotation link 780 may not include a sector gear. The rotation link 780 may include one end portion fixed by the link bracket 790 and the other end portion connected to the guide shaft 750. As the guide link 760 rotates, the rotation link 780 may rotate about the one end portion fixed to the link bracket 790.

In this way, the link bracket 790 may be fixed to the base frame 300 and may be coupled to the rotation link 780 such that the rotation link 780 is rotatably coupled to the link bracket 790.

The first connection shaft 820 may be connected to one of the pair of connection links 770 on the one side (e.g., the “Y” direction) in the second direction and may be connected to the other one of the pair of connection links 770 on the other side (e.g., the opposite direction of the “Y” direction) in the second direction.

According to this structure, due to the simple driving of the motor assembly 700, the guide shaft 750 extending in the second direction (e.g., the “Y” direction or the opposite direction thereof) may be raised or lowered by the guide link 760 and the rotation link 780, and the first connection shaft 820 may be raised or lowered by the pair of connection links 770.

Thus, the first connection areas 410 of the pair of seat frames 400 coupled to both end portions of the first connection shaft 820 in the second direction (e.g., the “Y” direction or the opposite direction thereof) may be raised or lowered.

The seat frame 400, combined with the connection bracket 500 via the third connection shaft 840 may be referred to as a bottom seat assembly, whereas the back frame 600 and the fourth connection shaft 850 may be referred to as a top seat assembly. The base frame 300 and the fixing bracket(s) 350 may be referred to as a seat base assembly. The seat base assembly (e.g., the base frame 300, the fixing bracket(s) 350, etc.), the bottom seat assembly (e.g., the seat frame 400, the connection bracket 500, the third connection shaft 840, etc.), the guide link 760, and the connection link 770 may form a moveable linkage (e.g., a closed-chain moveable linkage such as a four-bar linkage).

Hereinafter, a principle of rotating the back frame 600 (see FIG. 2) will be described in detail.

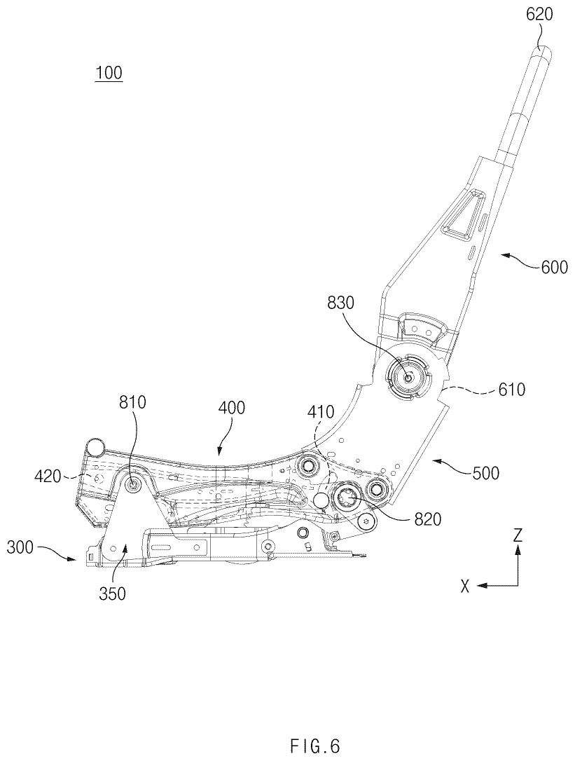

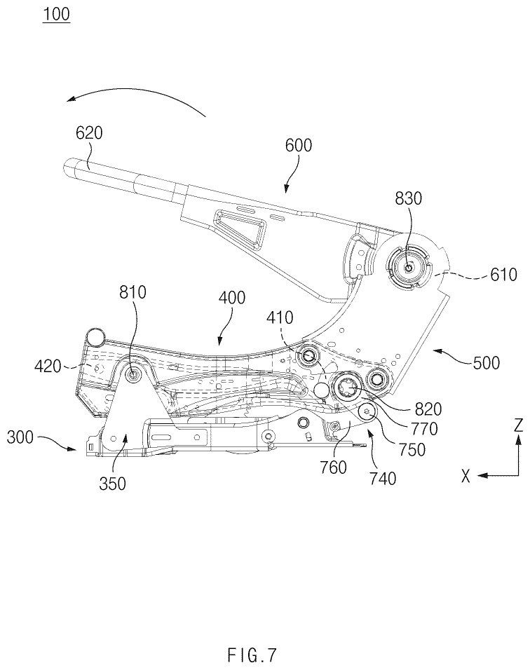

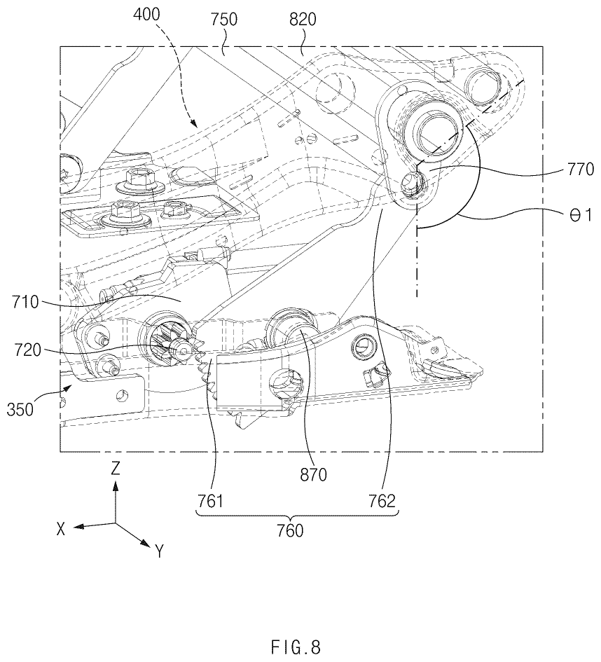

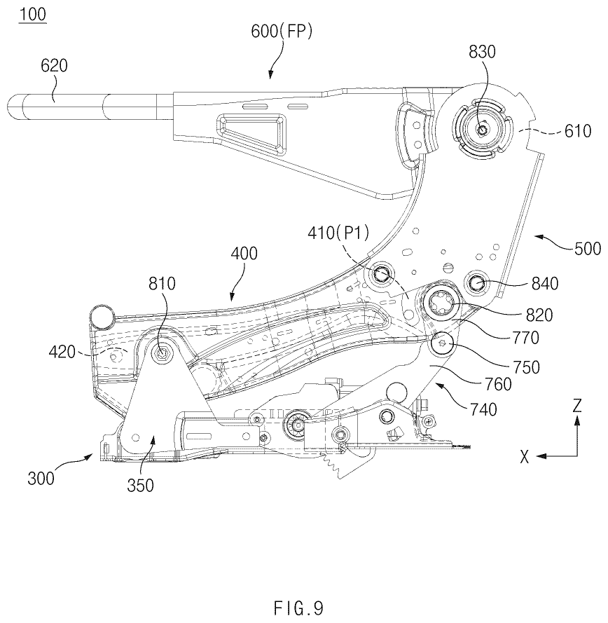

FIG. 6 is a side view of the seat apparatus before a back frame is rotated to a flat position. FIG. 7 is a side view of the seat apparatus when the back frame is rotated to the flat position. FIG. 8 is an enlarged view of the seat frame, a first connection shaft, the motor assembly, and the linkage assembly when the back frame is located at the flat position. FIG. 9 is a side view of the seat apparatus in a state in which the back frame is rotated to the flat position.

Referring to FIGS. 6 through 9, the back frame 600 of the seat apparatus 100 may be rotatable. The back frame 600 may include a first end portion (also referred to as a bottom end portion, a bottom end, or a hinge portion) 610 connected to the connection bracket 500 and a second end portion (also referred to as a top end portion, a top end, or a distal end portion) 620 provided on an opposite side of the first end portion 610.

The second end portion 620 of the back frame 600 may be rotated such that the second end portion 620 points in the first direction (e.g., the “X” direction) relative to the first end portion 610 of the back frame 600.

In other words, the back frame 600 may be foldable. The back frame 600 may be positioned in a flat position FP, in which the first end portion 610 and the second end portion 620 are arranged side-to-side (e.g., lie flat and/or cantilevered) in a horizontal direction (e.g., longitudinal direction).

The motor assembly 700 (e.g., the driving motor 710) may operate the movement (e.g., rotational movement) of the seat frame 400 such that the back frame 600 lies flat (e.g., parallel) relative to the floor (e.g., the floor of the vehicle). One or more sensors (e.g., a level sensor) may be installed (e.g., on the back frame 600 or anywhere else on the seat apparatus) and configured to detect the rotational position (e.g., angle) of the back frame 600 (e.g., relative to the base frame 300 and/or the floor of the vehicle). The one or more sensors may be communicatively connected to the motor assembly 700, such that the motor assembly 700 may determine (e.g., detect) whether or not the back frame 600 is in the flat position, and make any necessary movement adjustments. For example, the motor assembly 700 may include a controller (e.g., a processor) that receives sensor signals (e.g., signals indicating the rotational position of the back frame 600) from the one or more sensors, and control, based on the sensor signals, the driving motor 710 (e.g., control a rotational speed, a rotational direction, a duration of rotation, etc. of the driving motor 710) to ensure that the back from 600 (e.g., a back surface of the back frame 600, which may also be referred to as a top surface of the back frame 600 when the back frame 600 is in the folded position) is positioned flat (e.g., relative to the base frame 300 and/or the vehicle floor on which the seat apparatus is installed).

If the driving motor 710 is operated, the first connection shaft 820 may be raised by the guide link 760, the guide shaft 750, and the connection link 770. The connection link 770 may raise the first connection shaft 820 when (e.g., as while, after, etc.) the back frame 600 is rotated to the flat position FP.

While the first connection shaft 820 is raised, the first connection area 410 may be raised. A height of the first fixing area 420 may be maintained by the fixing shaft 810, and an area of the seat frame 400, which is located on the one side (e.g., the “X” direction) further along the first direction than the first fixing area 420, may be lowered.

Through this process, the back frame 600 may be rotated to the flat position FP. When the back frame 600 is disposed at the flat position FP, the first connection area 410 may be disposed at a first position P1. The first position P1 of the first connection area 410 may be higher than the first fixing area 420.

An angle between the guide link 760 and the connection link 770 when the back frame 600 is disposed at the flat position FP may be a first angle θ1. The first angle θ1 may be an obtuse angle.

When the back frame 600 is disposed at the flat position FP, an area of the seat frame 400, which located on the other side (e.g., the opposite direction of the “X” direction) in the first direction further than the fixing shaft 810, may be raised, and thus more areas of the seat frame 400 may be raised. Due to this structure, when the back frame 600 is disposed at the flat position FP, a lower space of the seat frame 400 may be used as a storage space, thereby improving space utilization of the vehicle.

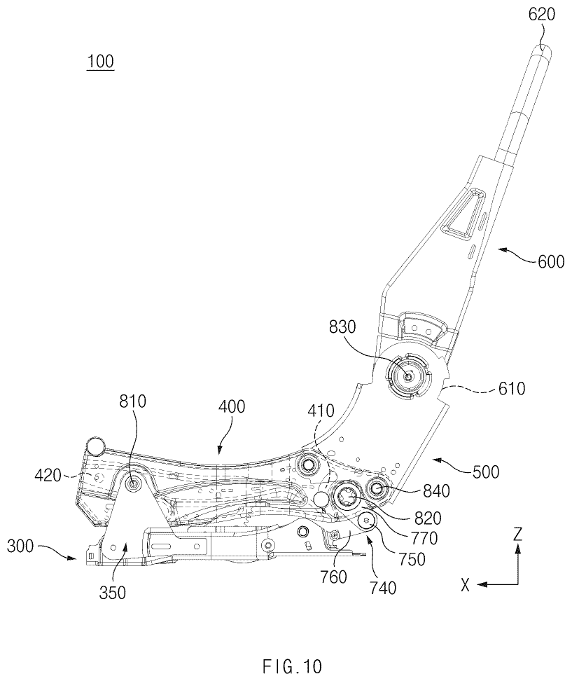

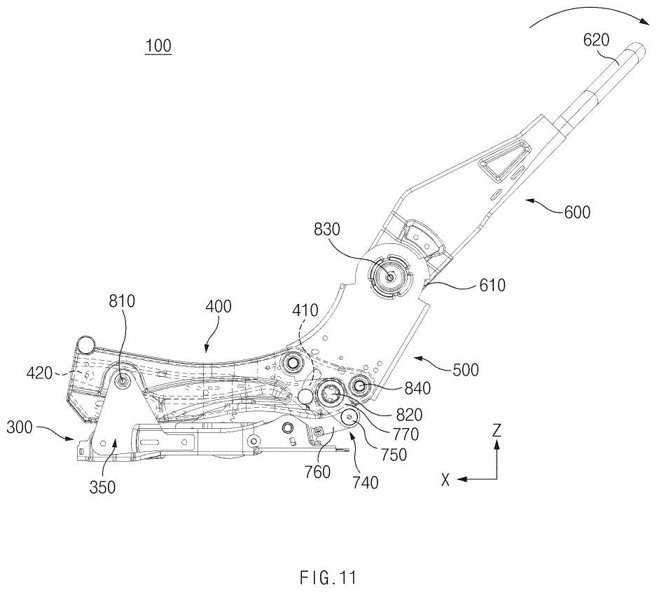

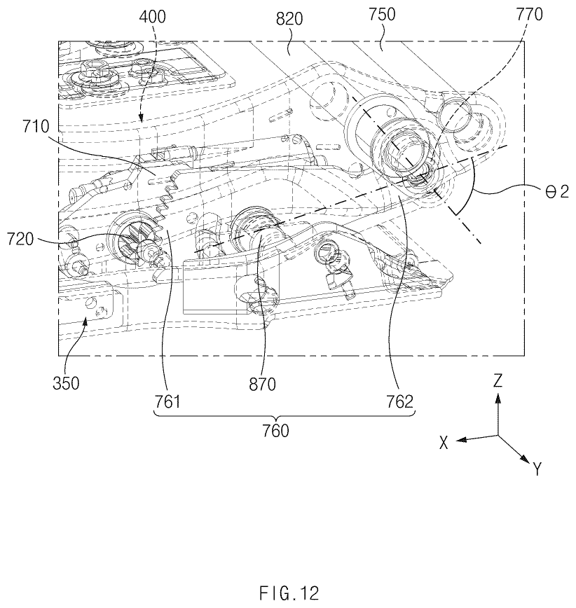

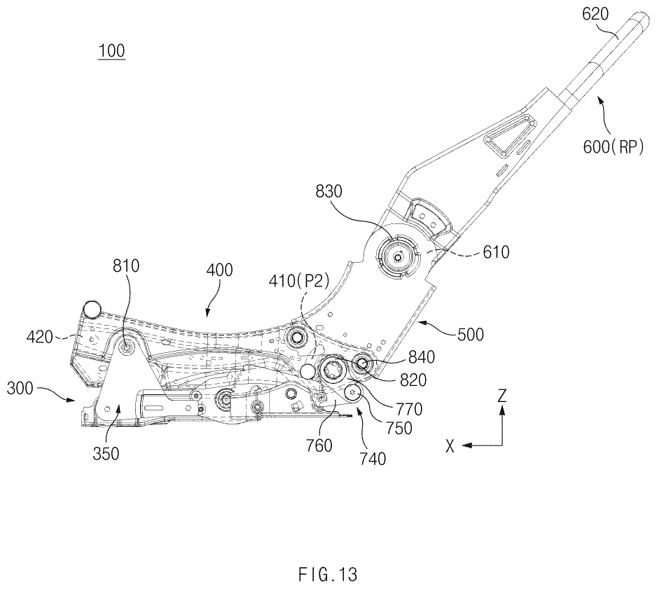

FIG. 10 is a side view of the seat apparatus before the back frame is rotated to a reclined position. FIG. 11 is a side view of the seat apparatus before the back frame is rotated to the reclined position. FIG. 12 is an enlarged view of the seat frame, the first connection shaft, the motor assembly, and the linkage assembly when the back frame is located at the reclined position. FIG. 13 is a side view of the seat apparatus in a state in which the back frame is rotated to the reclined position.

Referring to FIGS. 10 to 13, the back frame 600 may be reclined. The back frame 600 may be located at a reclined position RP in which the second end portion 620 is disposed on the other side (e.g., the opposite direction of the “X” direction) in the first direction further than the first end portion 610.

That is, the back frame 600 may be rotatably formed (e.g., rotate) between the flat position FP (see FIG. 9) and the reclined position RP.

In more detail, when (e.g., while, as, after, etc.) the driving motor 710 is operated, the first connection shaft 820 may be lowered by the guide link 760, the guide shaft 750, and the connection link 770. The connection link 770 may lower the first connection shaft 820 when the back frame 600 is rotated to the reclined position RP.

While the first connection shaft 820 is lowered, the first connection area 410 may be lowered. The height of the first fixing area 420 may be maintained by the fixing shaft 810, and an area of the seat frame 400, which is located on the one side (e.g., the “X” direction) in the first direction further than the first fixing area 420, may be raised.

Through this process, the back frame 600 may be rotated to the reclined position RP. When the back frame 600 is disposed at the reclined position RP, the first connection area 410 may be disposed at a second position P2. The second position P2 of the first connection area 410 may be lower than the first fixing area 420. Thus, the first position P1 of the first connection area 410 may be higher than the second position P2 of the first connection area 410.

The first connection area 410 may rotate between the first position P1 in which the back frame 600 is disposed at the flat position FP and the second position P2 in which the back frame 600 is disposed at the reclined position RP.

An angle between the guide link 760 and the connection link 770 when the back frame 600 is disposed at the reclined position RP may be a second angle θ2. The second angle θ2 may be an acute angle.

Thus, the first angle θ1 between the guide link 760 and the connection link 770 when the back frame 600 is disposed at the flat position FP may be formed to be greater than the second angle θ2 between the guide link 760 and the connection link 770 when the back frame 600 is disposed at the reclined position RP.

When the back frame 600 is disposed at the reclined position RP, an angle between the back frame 600 and the seat frame 400 may be obtuse, such that the user using the back frame 600 may lean his/her upper body back to enjoy a more comfortable ride.

Further, according to the present disclosure, driving (e.g., powering) of the motor assembly 700 may facilitate switching of the back frame 600 to the flat position FP or the reclined position RP, thereby improving the utility and versatility of the seat apparatus 100.

According to an aspect of the present disclosure, a seat apparatus includes a seat frame, a connection bracket rotatably coupled to the seat frame, a back frame rotatably coupled to the connection bracket and including one end portion connected to the connection bracket and the other end portion, a first connection shaft that is coupled to the seat frame and raises or lowers the seat frame, and a second connection shaft that is coupled to the connection bracket and the back frame and rotates the back frame about the connection bracket, wherein the back frame is rotatable between a flat position in which the one end portion and the other end portion are arranged side by side in a horizontal direction and a reclined position in which the other end portion is disposed behind the one end portion and reclined.

The seat frame may include a first connection area coupled to the first connection shaft, the first connection area may be rotated between a first position in which the back frame is disposed in the flat position and a second position in which the back frame is disposed in the reclined position, and the first position of the first connection area may be higher than the second position of the first connection area.

The seat apparatus may further include a base frame and a fixing bracket connecting the base frame and the seat frame, wherein the seat frame may further include a fixing area connected to the fixing bracket, the first position of the first connection area may be higher than a position of the fixing area, and the second position of the first connection area may be lower than the position of the fixing area.

The seat apparatus may further include a fixing shaft connecting the seat frame and the fixing bracket, wherein the seat frame may be configured to rotate about the fixing shaft.

The seat apparatus may further include a driving part that rotates the back frame, and a guide part connecting the driving part and the first connection shaft to raise or lower the first connection shaft by the driving part.

The guide part may include a guide link formed to rotate, a guide shaft connected to the guide link, and a connection link connecting the guide shaft and the first connection shaft.

The driving part may include a driving motor and a driving gear rotated by the driving motor, and the guide link may include a sector gear engaged with the driving gear.

The guide link may include one end portion including the sector gear and the other end portion connected to the guide shaft.

The connection link may raise the first connection shaft when the back frame is rotated to the flat position, and lower the first connection shaft when the back frame is rotated to the reclined position.

A first angle between the guide link and the connection link when the back frame is disposed at the flat position may be greater than a second angle between the guide link and the connection link when the back frame is disposed at the reclined position.

The connection link may be provided as a pair of connection links, the guide shaft may be connected to the guide link on one side thereof, the first connection shaft may be connected to one of the pair of connection links on one side thereof, the guide part may further include a rotation link connected to the guide shaft on the other side of the guide shaft, and the first connection shaft may be connected to the other one of the pair of connection links on the other side thereof.

The seat apparatus may further include a base frame, wherein the guide part may further include a link bracket which is fixed to the base frame and to which the rotation link is rotatably coupled.

The seat apparatus may further include a base frame, wherein the driving part may further include a motor bracket that fixes the driving motor and is coupled to the base frame.

The seat frame may include a second connection area connected to the connection bracket, and the seat apparatus may further include a third connection shaft connecting the second connection area and the connection bracket and located behind the first connection shaft.

In the present technology, when a seat apparatus is folded, a rear area of a seat frame may be raised, a lower space of the seat frame may be utilized as a storage space, and thus space utilization may be improved.

Further, in the present technology, switching of a seat apparatus between a flat position and a reclined position may be manipulated by simple driving of a driving part, and thus productivity of the seat apparatus may be improved.

In addition, various effects directly or indirectly identified though the present document may be provided.

The above description is merely illustrative of the technical spirit of the present disclosure, and those skilled in the art to which the present disclosure belongs may make various modifications and changes without departing from the essential features of the present disclosure.

Thus, the example embodiments disclosed in the present disclosure are not intended to limit the technology spirit of the present disclosure but are intended to describe the present disclosure, and the scope of the technical spirit of the present disclosure is not limited by these embodiments. The scope of protection of the present disclosure should be interpreted by the appended claims, and all technical spirits within the scope equivalent thereto should be interpreted as being included in the scope of the present disclosure.

What is claimed is:

1. A seat apparatus comprising:
a seat frame;
a connection bracket coupled to the seat frame;
a back frame comprising a hinge portion and a distal end portion, wherein the hinge portion is coupled to the connection bracket;
a first connection shaft coupled to the seat frame and configured to raise or lower the seat frame; and
a second connection shaft coupled to the connection bracket and the back frame,
wherein the back frame is configured to pivot around the second connection shaft between:
a flat position, in which the hinge portion and the distal end portion are arranged in a horizontal direction; and
a reclined position, in which the distal end portion is reclined and disposed to be further away from the seat frame than the hinge portion.

2. The seat apparatus of claim 1, wherein the seat frame comprises a first moveable attachment site, to which the first connection shaft is coupled,
wherein the first moveable attachment site is configured to move between:
a first position, in which the back frame is disposed in the flat position, and
a second position, in which the back frame is disposed in the reclined position, and
wherein the first position of the first moveable attachment site is higher than the second position of the first moveable attachment site.

3. The seat apparatus of claim 2, further comprising:
a base frame; and
a fixing bracket connecting to the base frame and the seat frame,
wherein the seat frame further comprises a non-movable attachment site, to which the fixing bracket is coupled,
wherein the first position of the first moveable attachment site is higher than a position of the non-movable attachment site, and
wherein the second position of the first moveable attachment site is lower than the position of the non-movable attachment site.

4. The seat apparatus of claim 3, further comprising:
a non-moveable shaft connecting to the seat frame and the fixing bracket,
wherein the seat frame is configured to pivot around the non-moveable shaft.

5. The seat apparatus of claim 1, further comprising:
a motor assembly configured to generate mechanical power; and
a linkage assembly connecting to the motor assembly and the first connection shaft, and configured to transmit the mechanical power generated by the motor assembly to the first connection shaft to raise or lower the first connection shaft and cause pivoting movement of the back frame.

6. The seat apparatus of claim 5, wherein the linkage assembly comprises:
a pivot arm;
a pivot arm shaft coupled to the pivot arm; and
a connection link connecting to the pivot arm shaft and the first connection shaft.

7. The seat apparatus of claim 6, wherein the motor assembly comprises a motor and a driving gear, wherein the motor is configured to rotate the driving gear, and
wherein the pivot arm comprises a sector gear configured to engage the driving gear.

8. The seat apparatus of claim 7, wherein the sector gear is disposed at a first end portion of the pivot arm, and wherein a second end portion of the pivot arm is coupled to the pivot arm shaft.

9. The seat apparatus of claim 6, wherein the connection link is configured to:
raise the first connection shaft to pivot the back frame to the flat position; and
lower the first connection shaft to pivot the back frame to the reclined position.

10. The seat apparatus of claim 6, wherein a first angle between the pivot arm and the connection link when the back frame is disposed in the flat position is greater than a second angle between the pivot arm and the connection link when the back frame is disposed in the reclined position.

11. The seat apparatus of claim 6, wherein the connection link comprises a first connection link and a second connection link,
wherein the pivot arm is connected to a first end of the pivot arm shaft,
wherein the linkage assembly further comprises a pivot link coupled to a second end of the pivot arm shaft,
wherein a first end of the first connection shaft is coupled to the first connection link, and
wherein a second end of the first connection shaft is coupled to the second connection link.

12. The seat apparatus of claim 11, further comprising:
a base frame,
wherein the linkage assembly further includes:
a link bracket which is affixed to the base frame and to which the pivot link is rotatably coupled.

13. The seat apparatus of claim 7, further comprising:
a base frame,
wherein the motor assembly further comprises:
a motor bracket coupled to the base frame and configured to affix the motor to the base frame.

14. The seat apparatus of claim 2, wherein the seat frame comprises a second moveable attachment site, to which the connection bracket is coupled, and
wherein the seat apparatus further comprises a third connection shaft disposed behind the first connection shaft, wherein the third connection shaft connects to the connection bracket and the second moveable attachment site of the seat frame.

15. A seat apparatus comprising:
a seat base assembly configured to affix to a floor of a vehicle;
a bottom seat assembly, wherein a front portion of the bottom seat assembly is coupled, via a first pivot shaft, to a front portion of the seat base assembly, wherein the bottom seat assembly is configured to pivot around the first pivot shaft;
a top seat assembly coupled to a back portion of the bottom seat assembly;
a jointed linkage comprising a first link arm and a second link arm, wherein the first link arm is coupled to the second link arm, wherein the first link arm is coupled, via a second pivot shaft, to a back portion of the seat base assembly, and wherein the second link arm is coupled, via a third pivot shaft, to the bottom seat assembly, such that the seat base assembly, the bottom seat assembly, and the jointed linkage form a closed-chain moveable linkage; and
a motor assembly coupled to the seat base assembly and engaging the jointed linkage, wherein the motor assembly is configured to provide mechanical power to operate the closed-chain moveable linkage to raise or lower the back portion of the bottom seat assembly relative to the front portion of the bottom seat assembly.

16. The seat apparatus of claim 15, wherein the first link arm comprises a sector gear, and wherein the motor assembly comprises:
a driving gear engaging the sector gear; and
a motor coupled to the driving gear and configured to cause, via the driving gear and the sector gear, the first link arm to pivot around the second pivot shaft.

17. The seat apparatus of claim 15, wherein the top seat assembly is coupled, via a fourth pivot shaft, to the back portion of the bottom seat assembly, and wherein the top seat assembly is configured to pivot around the second pivot shaft between a folded position and a reclined position.

18. The seat apparatus of claim 17, wherein the motor assembly is configured to, based on the top seat assembly being disposed in the folded position, operate the closed-chain moveable linkage such that a top surface of the top seat assembly, in the folded position, is positioned to be parallel to the floor of the vehicle.

19. The seat apparatus of claim 18, further comprising:
one or more sensors configured to generate a signal indicating a rotational position, relative to the floor of the vehicle, of the top seat assembly,
wherein the motor assembly further comprises a controller communicatively connected to the one or more sensors, and
wherein the controller is configured to operate, based on the signal received from the one or more sensors, the closed-chain moveable linkage such that the top surface of the top seat assembly, in the folded position, is positioned to be parallel to the floor of the vehicle.
